(19) United States
(12) Patent Application Publication
(10) Pub. No.: US 2003/0016602 A1
(43) Pub. Date: Jan. 23, 2003

(54) Optical disk apparatus

(76) Inventors: Yasuhiro Wada, Fukuoka (JP); Keisuke Umeda, Fukuoka (JP); Kenji Utsunomiya, Fukuoka (JP); Takayuki Oie, Fukuoka (JP); Fuminobu Furukawa, Fukuoka (JP)

Correspondence Address: RATNERPRESTIA, P O BOX 980, VALLEY FORGE, PA, 19482-0980, US

(21) Appl. No.: 10/172,717

(22) Filed: Jun. 14, 2002

(30) Foreign Application Priority Data
Jun. 18, 2001 (JP) 2001-183174
Jun. 18, 2001 (JP) 2001-183175

(51) Int. Cl. G11B 7/0045

(52) U.S. Cl. 369/47.3; 369/47.33; 369/47.31

(57) ABSTRACT

An optical disk apparatus, which decreases probability of impossibility of correcting an error in reading, is provided, where the error results from deviation of a writing-resuming position in resumption of writing. When an amount of data in a buffer becomes not more than a given amount of data, a buffer-underrun-detecting-circuit judges that the data are in a buffer-underrun-condition. According to the judgement, a writing-interrupting-and-resuming-circuit detects an end position of the last pit for writing, and the position is stored in a time-information-memory, and the optical disk apparatus becomes in a pause condition of writing. When the buffer-underrun-condition is avoided, the optical disk apparatus releases the pause condition of writing, and reads the position of interruption of writing from the time-information-memory, and then synchronizes data written on an optical disk and the data for writing. After that, writing is resumed with a given interval formed between the data written and the data for writing.

### FIELD OF THE INVENTION

The present invention relates to an information-writing device for writing information additionally on an information-writing medium. Particularly, this invention relates to an optical disk apparatus, which stops writing when a buffer-underrun condition occurs, and resumes writing when the buffer-underrun condition is avoided.

### BACKGROUND OF THE INVENTION

When laser beam is irradiated from an optical head to an information-writing medium such as an optical disk, reflectance of the information-writing medium is changed, so that writing is executed.

In the writing process, an input data for writing is transferred from a host computer to an optical disk apparatus, and then the input data is stored temporarily in a buffer memory for inputting. After that, the data is read, and the laser beam is irradiated from the optical head to the medium based on the data, whereby the data is written.

Unbalance between a transfer rate of the input data from the host computer to the optical disk apparatus and a transfer rate (writing rate) of the input data from the optical head to the medium occurs frequently. For example, the transfer rate from the host computer to the optical disk tends to become later than the transfer rate from the optical head to the medium. This unbalanced condition causes a buffer-underrun condition (empty condition of the buffer memory). If the buffer-underrun condition occurs, data written on the medium are interrupted and the medium can not be used.

A conventional optical disk apparatus for preventing the buffer-underrun condition works as follow. Data stored in the buffer memory are monitored, and writing is stopped when the buffer-underrun condition occurs. After that, when new data are stored in the buffer memory, and the buffer-underrun condition is avoided, the writing is resumed from an interrupted position for continuing the data. When the buffer-underrun condition occurs, the interrupted and resumed position for the media is determined in EFM (eight to fourteen modulation) frames as disclosed in Japanese Patent Application Non-Examined Publication No. H10-49990 and H3-163064.

A principle of the writing on the information-writing media is described hereinafter. Optical energy of laser irradiated from an optical pick-up is absorbed in a writing film and changed into heat energy, and optical characteristics of the media is partially changed by changing a temperature on the writing film, so that pits corresponding to writing data are formed. When the writing is interrupted and resumed, delay of heat occurs on the writing film due to radiation of heat or leading-edge characteristics of the laser. As a result, an irregular section by changing of a structure of the writing film tends to be formed at a starting position or an end position of the pit. In other words, the starting position or the end position of the pit can not be detected clearly and the medium can not be reproduced in the reading process.

The position interrupted and resumed of writing is not always a space between pits. When the end position of the pit before interrupting and the starting position of the pit after resuming are connected and form one pit, the discontinuity section occurs at a pit-connected part, thereby causes an error.

Writing is resumed from the head of the flames because the writing is interrupted in frames. In the resumption of writing process, if a position of a frame-sync signal is written on the wrong place due to a controlling error of a spindle motor, lack of synchronism occurs in the reading process, so that a reading data becomes an error. In this case, the medium can not be reproduced too.

### SUMMARY OF THE INVENTION

The present invention aims to provide an optical disk apparatus, which decreases substantially probability of impossibility of correcting an error in a reading process, where the error results from deviation of a writing-resuming position in resumption of a writing process.

The optical disk apparatus for writing data on an optical disk includes the following elements:

(a) a buffer-underrun-detecting means for monitoring an amount of data stored temporarily in a buffer, namely, an amount of data for writing, and judging that the data are in a buffer-underrun condition when the amount of the data becomes not more than a given amount of data,

(b) a writing interrupting and resuming means for writing the data on the optical disk at a given position,

(c) a time-information memory for storing the data of the last time of interrupted writing or an address,

(d) a synchronizing means for synchronizing the data written on the optical disk and a given clock signal, and

(e) a modulating means for synchronizing the data for writing and the given clock signal, and outputting a synchronized data after modulating,

where a given space is provided between the data written on the optical disk and the data for resumption of writing, and writing is resumed.

The optical disk apparatus of this invention includes the following elements:

(a) a buffer-underrun-detecting means for monitoring an amount of data stored temporarily in a buffer, namely, an amount of data for writing, and judging that the data are in a buffer-underrun condition when the amount of the data becomes not more than a given amount of data,

(b) a writing interrupting and resuming means for writing the data on the optical disk at a given position,

(c) a time-information memory for storing the data of the last time of interrupted writing or an address,

(d) a synchronizing means for synchronizing the data written on the optical disk and a given clock signal, and

(e) a modulating means for synchronizing the data for writing and the given clock signal, and outputting a synchronized data after modulating,

where when the buffer-underrun-detecting means judges that the data are in a buffer-underrun condition, and the writing interrupting and resuming means detects a position for interrupting of writing, the writing is interrupted within an area from the last position of a frame for interrupting to a position of a maximum possible number for correcting which the optical disk has,

where when the buffer-underrun-detecting means judges that the data are in an avoidance of the buffer-underrun condition, the data written on the optical disk and the data for resuming writing are synchronized, and writing is resumed at a position, which is a result of counting channel bits and within an area from the last position of the interrupted frame to the position of the maximum possible number for correcting which the optical disk has.

In the case of a rewritable optical disk apparatus of this invention, after the interruption of writing, at least an area of the maximum pit length of an optical disk standard after the end position of the pit is initialized.

This invention can provide the optical disk apparatus, which decreases substantially probability of impossibility of correcting the error in the reading process, where the error results from deviation of the writing-resuming position in the resumption of the writing process.

### BRIEF DESCRIPTION OF THE DRAWINGS

FIG. 1 shows a block diagram explaining a structure of an optical disk apparatus in accordance with exemplary embodiments of the present invention.

FIG. 2 is a timing chart explaining interrupting and resuming of writing of the optical disk apparatus shown in FIG. 1.

FIG. 3 shows a flowchart explaining interrupting and resuming of writing of the optical disk apparatus of the present invention.

FIG. 4 shows a chart explaining an interrupted and resumed position of writing of the optical disk apparatus in accordance with a second embodiment of the present invention.

FIG. 5 shows a flowchart explaining interrupting and resuming of writing of the optical disk apparatus in accordance with the second embodiment of the present invention.

FIG. 6 shows a chart explaining influence by an even-delaying operation of cross-interleaved-Reed-Solomon-code (CIRC) of the optical disk apparatus of the present invention.

FIG. 7 shows a flowchart explaining interrupting and resuming of writing of the optical disk apparatus in accordance with a third embodiment of the present invention.

FIG. 8 shows a block diagram explaining a structure of the optical disk apparatus in accordance with a fourth embodiment of the present invention.

FIG. 9 shows a timing chart explaining interrupting and resuming of writing of the optical disk apparatus using a CD-RW in accordance with the fourth embodiments of the present invention.

FIG. 10 is a flowchart explaining interrupting and resuming of writing of the optical disk apparatus shown in FIG. 9.

### DETAILED DESCRIPTION OF THE INVENTION

### First Embodiment

The first exemplary embodiment of the present invention is demonstrated hereinafter with reference to the accompanying drawings.

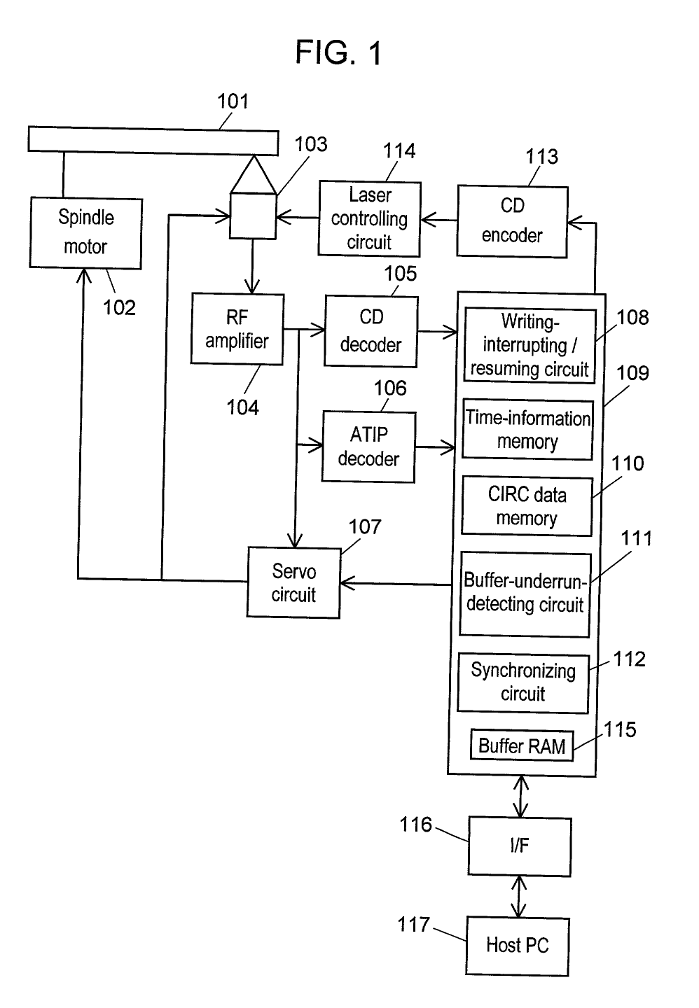

FIG. 1 shows a block diagram explaining a structure of an optical disk apparatus of the present invention. Components are explained hereinafter with reference to FIG. 1.

Optical disk 101 is an information-writing medium such as CD-R, CD-RW, DVD-R or DVD-RW, on which data are written, and includes a writable information-writing layer. A CD-Recordable (CD-R) and a CD-Rewritable (CD-RW) based on the CD standards are described hereinafter, where the CD-R is referred to as a write-once-read-many optical disk and the CD-RW is referred to as a rewritable optical disk.

Spindle motor 102 is a rotating-driving means for driving and rotating optical disk 101. Optical pick-up 103 irradiates laser beam on a writing surface of optical disk 101, thereby writes data on optical disk 101, or optical pick-up 103 detects reflected light, thereby reproduces the data.

RF amplifier 104 amplifies a RF signal obtained from optical pick-up 103 and outputs a signal. CD decoder 105 is a demodulating means for binarizing and demodulating the signal obtained from RF amplifier 104. Absolute time in pre-groove (ATIP) decoder 106 is an ATIP demodulating means for extracting a wobble signal from a pre-groove signal, which is obtained from RF amplifier 104, of optical disk 101, and demodulating ATIP.

Servo circuit 107 executes focus-controlling, tracking-controlling, traverse-controlling and spindle-controlling. Focus-controlling focuses the laser beam, which is irradiated from optical pick-up 103, on the writing surface of optical disk 101. Tracking-controlling allows the laser beam to track tracks of optical disk 101. Traverse-controlling moves optical pick-up 103 to a radial direction of optical disk 101. Spindle-controlling rotates spindle motor 102 with constant linear velocity.

Writing-interrupting-and-resuming circuit 108 is a writing interrupting and resuming means for interrupting data of writing, and resuming data of writing on optical disk 101 at a given position. Time-information memory 109 is a time-information means for storing time-information of the last frame and a frame number, where the time-information is written before interrupting of writing. According to CD standards, the time-information and the address-information become the same meaning in controlling, because the time-information can be changed to address-information.

Cross-interleaved-Reed-Solomon-code (CIRC) data memory 110 stores written data satisfying an interleaving-length of CIRC, which are required at a resumption of writing process. Data for writing are stored in CIRC data memory 110 in a writing process. Buffer-underrun-detecting circuit 111 is a buffer-underrun-detecting means for monitoring an amount of data of buffer RAM 115, where buffer RAM 115 is a buffer for storing input data for writing. When the amount of the data becomes not more than a given amount of data, circuit 111 judges that the data are in a buffer-underrun condition. In addition to that, when the amount of the data becomes not less than a given amount of data, which is different from the given amount of the data in the buffer-underrun condition, circuit 111 judges that the data are an avoidance of the buffer-underrun condition.

Host personal computer (host PC) 117 is coupled with the optical disk apparatus via interface circuit 116, where interface circuit 116 is a interface for connecting host PC 117 with the optical disk apparatus. Buffer RAM 115 temporarily stores the data for writing sent from host PC 117 via interface circuit 116.

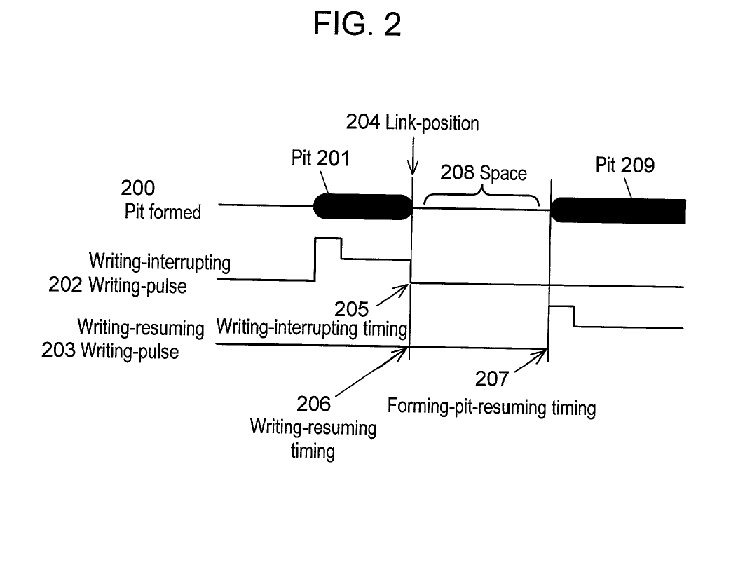

Synchronizing circuit 112 is a synchronizing means for synchronizing the data written on optical disk 101 and a reference clock signal in the optical disk apparatus. CD encoder 113 is a modulating means for synchronizing the data of information for writing and the reference clock signal in the optical disk apparatus, and for outputting after modulating. As shown in FIG. 2, the writing data have a data structure that pit 201 synchronized the reference clock signal is arrayed, so that positions for forming pits and positions for blanks (not forming pits) are recognized based on the reference clock signal.

Laser controlling circuit 114 is a laser controlling means for controlling light power, i.e., output of the laser beam, based on the writing data of CD encoder 113.

An operation of interrupting and resuming of writing of the optical disk apparatus in accordance with the first embodiment is described hereinafter. When a writing operation is instructed, input data are sent from host PC 117 to buffer RAM 115 via interface circuit 116, and stored in buffer RAM 115. When buffer-underrun-detecting circuit 111 detects that the amount of the data in buffer RAM 115 is not less than a given amount of data, the data in buffer RAM 115 are sent to CD encoder 113 by instruction of starting of writing of the optical disk apparatus. CD encoder 113 adds an error-detecting code and an error-correcting code to the input data, executes eight-to-fourteen-modulation (EFM) operation, adds a synchronized signal to the input data based on the CD standards and sends the data to laser-controlling circuit 114 directly. After that, the laser-controlling circuit 114 controls an output of the laser of optical pick-up 103, and optical pick-up 103 writes the data on optical disk 101.

When a transfer rate of the input data for storing, which are sent from host PC 117, is later than a transfer rate of the data for writing, which are sent from CD encoder 113, the amount of the data stored in buffer RAM 115 decreases. When the amount of the data in buffer RAM 115 becomes not more than the given amount of the data and buffer-underrun-detecting circuit 111 detects a condition near the buffer-underrun condition, the optical disk apparatus sends an interrupting-instruction of writing to CD encoder 113, thereby becomes in a pause condition of writing.

In the pause condition of writing, new data sent from host PC 117 are stored in buffer RAM 115, and the amount of the data in buffer RAM 115 becomes not less than the given amount of the data. As a result, buffer-underrun-detecting circuit 111 judges that the data in buffer RAM 115 are in the avoidance of the buffer-underrun condition. The optical disk apparatus sends a resuming-instruction of writing to CD encoder 113, and releases the pause condition of writing.

The operation of interrupting and resuming of writing of the optical disk apparatus is described in detail hereinafter.

FIG. 2 is a timing chart explaining interrupting and resuming of writing of the optical disk apparatus shown in FIG. 1.

FIG. 2 shows pit 200 for forming and writing-pulses 202, 203. As shown in FIG. 2, at pit 200 for forming, pit 201 is formed on optical disk 101 before interrupting of writing, and pit 209 is formed on optical disk 101 after resuming of writing. Writing-pulse 202 before interrupting of writing, and writing-pulse 203 after resuming of writing are shown in FIG. 2. Link-position 204 is an end position of pit 201 at interrupting of writing, and a joint of interrupting and resuming of writing. Writing-interrupting timing 205 is an end position of writing-pulse 202, which forms continuous pit 201 before interrupting of writing. Writing-resuming timing 206 and forming-pit-resuming timing 207 of writing-pulse 203 are also shown in FIG. 2.

Writing-interrupting and writing-resuming are executed in the following procedures.

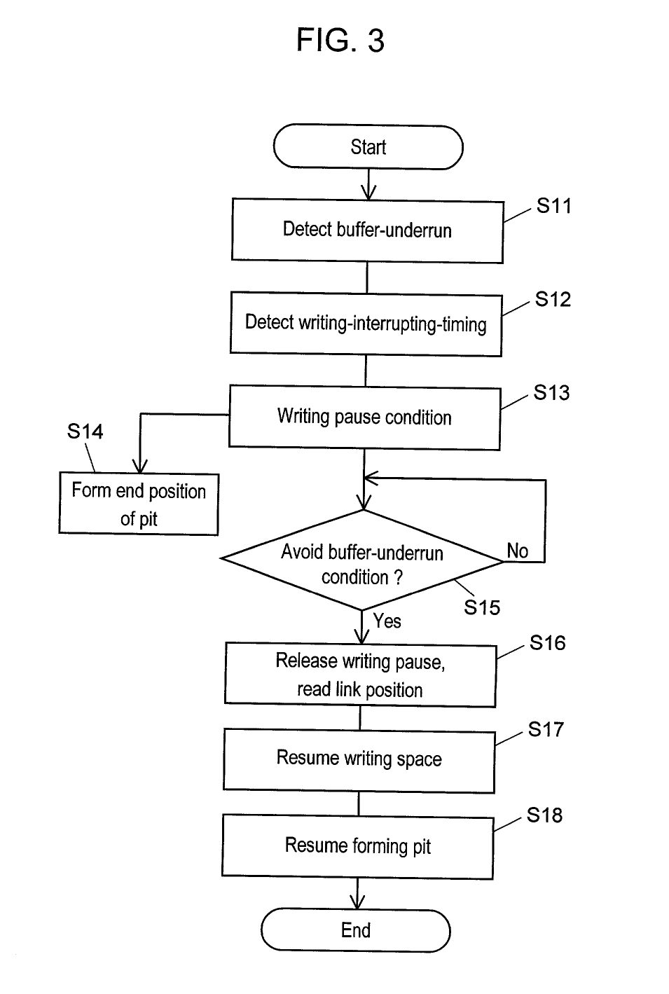

FIG. 3 shows a flowchart explaining interrupting and resuming of writing of the optical disk apparatus of the present invention.

In FIG. 1 through FIG. 3, interrupting of writing on CD-R is executed at link-position 204 after forming continuous pit 201.

In step 11, when the amount of the data in buffer RAM 115 is not more than the given amount of the data, buffer-underrun-detecting circuit 111 detects the buffer-underrun condition.

In step 12, based on the result of the buffer-underrun condition, writing-interrupting-and-resuming circuit 108 detects the end position of pit 201 in writing-pulse 202, as writing-interrupting timing 205, among data rows which are controlled by CD encoder 113.

In step 13, the optical disk apparatus sends the interrupting-instruction of writing to CD encoder 113, thereby becomes in the pause condition of writing.

In step 14, writing-pulse 202 is interrupted at the position of writing-interrupting timing 205, and forms the end position of pit 201, so that the end position of pit 201 becomes link-position 204.

An address of link-position 204 is stored in time-information memory 109, because an address-information of the optical disk can be changed time-information.

In step 15, in the pause condition of writing, new data sent from host PC 117 are stored in buffer RAM 115, and the amount of the data in buffer RAM 115 becomes not less than the given amount of the data. As a result, buffer-underrun-detecting circuit 111 judges that the data in buffer RAM 115 are in the avoidance of the buffer-underrun condition.

In step 16, the optical disk apparatus sends the resuming-instruction of writing to CD encoder 113, and releases the pause condition of writing. The optical disk apparatus reads the address of link-position 204 from time-information memory 109, and reads new data from buffer RAM 115, where link-position 204 is the position of interrupting of writing. Then the optical disk apparatus synchronizes link-position 204 written on optical disk 101 and encode data of CD encoder 113 (data for writing).

A first data written after the resumption of writing (after writing-resuming timing 206) is space 208 (condition without pits). In other words, writing-resuming timing 206 is formed after forming continuous pit 201, so that space 208 certainly appears at a start of writing-resuming timing 206.

In step 17, this first space 208 is written as a new data, namely, writing-pulse 203 does not exist.

In step 18, an output of writing-pulse 203 is started from forming-pit-resuming timing 207, namely, writing-pulse 203 becomes active, and light power for forming next pit 209 is irradiated from optical pick-up 103.

Link-position 204 is formed between pit 201 and space 208 in this invention. In other words, writing is interrupted at the position, where space 208 is formed after pit 201, and writing is resumed at the position.

As a result, regular edges are formed at pit 201 and pit 209, and discontinuity section does not occur during interrupting and resuming of writing.

Thus the optical disk apparatus in the present invention decreases substantially probability of impossibility of correcting the error in the reading process, where the error results from deviation of the writing-resuming position in the resumption of the writing process.

Besides the case that buffer-underrun-detecting circuit 111 detects the buffer-underrun condition discussed above, the writing method of information of this invention can be used for interrupting and resuming of writing generally.

### Second Embodiment

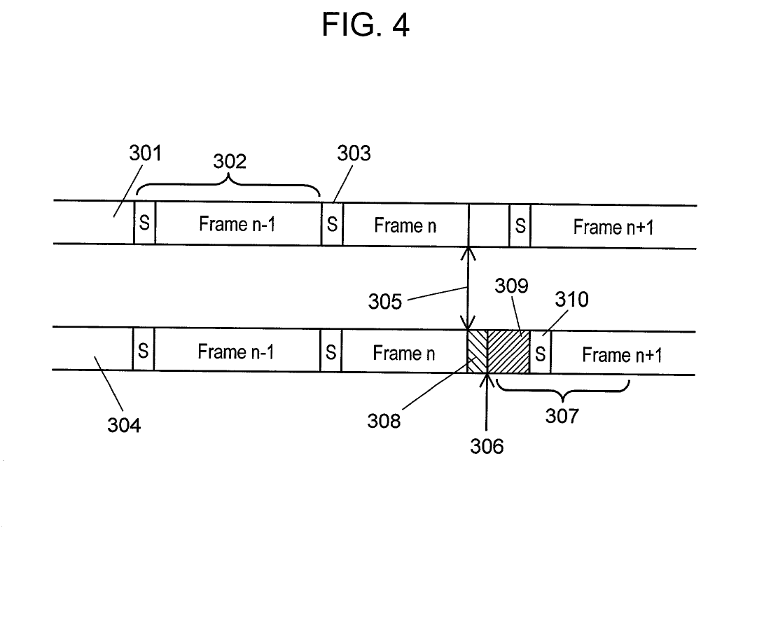

A structure of an optical disk apparatus of the second embodiment is the same as that in FIG. 1. FIG. 4 shows a chart explaining an interrupted and resumed position of writing of the optical disk apparatus in accordance with the second embodiment of the present invention. Writing data synchronized with a reference clock signal are arrayed by CD encoder 113. Writing data 301 for writing on optical disk 101 is shown in FIG. 4. Frame 302 is a writing-data row formed of 588 channel bits. Frame 302 is a minimum unit, and a writing data is generally formed of a plurality of frame 302.

Frame-sync signal 303 is disposed at the head of frame 302, and used for synchronizing the data for writing and the reference clock signal in the optical disk apparatus in a reading process.

In FIG. 4, writing data 304 is a data written on optical disk 101 or a data written after interrupting and resuming of writing. Writing-interrupting position 305 of frame n is a position for interrupting writing when a buffer-underrun condition occurs, and corresponds to link-position 204 in FIG. 2. Writing-resuming position 306 is a position for resuming writing when a buffer-underrun condition is avoided, and corresponds to forming-pit-resuming timing 207 in FIG. 2. Writing data 307 is a data written on optical disk 101 after resuming of writing, where position deviation 308 is disposed between frame n and writing data 307.

Position deviation 308 is a deviation between writing-interrupting position 305 and writing-resuming position 306. Position deviation 308 results from an error of controlling of a spindle motor or jitter of reproduced signals. Writing data 309, which is written after resuming of writing, is a data written from writing-resuming position 306 to first frame-sync signal 310.

As shown in the upper part of FIG. 4, writing data 301 shows an ideal condition without a deviation of position at writing-interrupting position 305. As shown in the lower part of FIG. 4, writing data 304 shows a condition having position deviation 308 at writing-interrupting position 305.

The writing data formed by an operation of interrupting and resuming of writing of the optical disk apparatus in accordance with the second embodiment is described hereinafter.

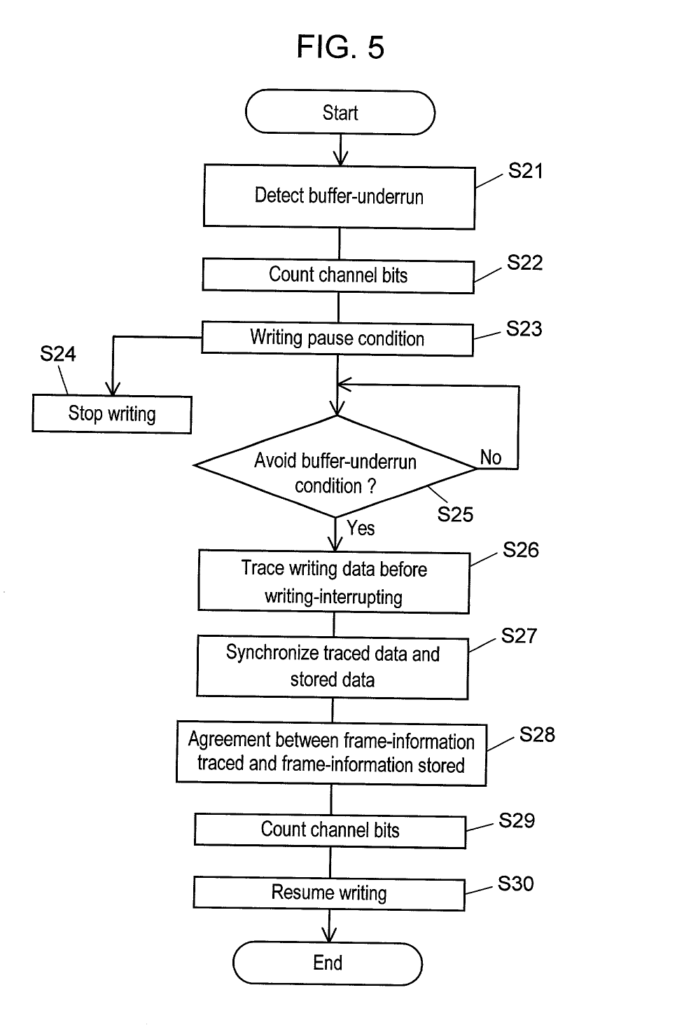

FIG. 5 shows a flowchart explaining interrupting and resuming of writing of the optical disk apparatus in accordance with the second embodiment of the present invention.

In step 21, as shown in FIGS. 1, 4 and 5, when an amount of data in buffer RAM 115 is not more than a given amount of data, buffer-underrun-detecting circuit 111 detects the buffer-underrun condition, and informs a buffer-underrun condition to writing-interrupting-and-resuming circuit 108.

In step 22, writing-interrupting-and-resuming circuit 108 counts channel bits using frame-sync signal 303 of frame n, which is an object for interrupting of writing, among data rows, which are controlled by CD encoder 113, based on the result of the buffer-underrun condition.

In step 23, when the result of counting reaches within 4 bytes from the last of frame n for interrupting, the optical disk apparatus sends the interrupting-instruction of writing to CD encoder 113, thereby becomes in a pause condition of writing.

In step 24, time-information memory 109 stores frame-information of the interruption of writing according to the pause condition of writing. CD encoder 113 stops outputting to laser controlling circuit 114 according to the interrupting-instruction of writing, thereby stops writing on optical disk 101.

The position for interrupting of writing is writing-interrupting position 305, and is not necessarily the end position of pit 201. Writing-interrupting position 305 can be formed within 4 bytes from the last of frame n, namely, position 305 can be formed on the way to pit 201. The second embodiment is different from the first embodiments in this position.

In step 25, in the pause condition of writing, data for writing are sent from host PC 117, and new data are stored in buffer RAM 115, whereby the amount of the data in buffer RAM 115 becomes not less than the given amount of the data. As a result, buffer-underrun-detecting circuit 111 that the data in buffer RAM 115 are in the avoidance of the buffer-underrun condition.

In step 26, the optical disk apparatus informs resumption of writing to writing-interrupting-and-resuming circuit 108 based on the detected result of buffer-underrun-detecting circuit 111. Circuit 108 moves optical pick-up 103 to a position before writing-interrupting position 305 on optical disk 101 by using servo circuit 107, and traces writing data 304 which is written on optical disk 101 before interrupting of writing.

In step 27, CD encoder 113 reads a stored data from cross-interleaved-Reed-Solomon-code (CIRC) data memory 110, and encodes the data. Synchronizing circuit 112 synchronizes the encoded data and writing data 304, which is traced and reproduced, and informs completion of synchronism to writing-interrupting-and-resuming circuit 108.

In step 28, circuit 108 obtains address-information from a sub code data decoded by CD decoder 105 or absolute time in pre-groove (ATIP), which is decoded by ATIP decoder 106, and operates CD encoder 113. Then circuit 108 synchronizes writing data 304 written on optical disk 101 and the encoded data (data for writing) of CD encoder 113. Circuit 108 waits agreement between frame-information, which is stored in time-information memory 109 at the interruption of writing, and the address-information and frame-information, which are being traced.

In step 29, when both frame-information agree each other, circuit 108 counts channel bits using frame-sync signal 303 of interrupted frame n.

In step 30, when the result of counting is within 4 bytes from the last of frame n, and agrees with the number of channel bits, which is stored in memory 109 and shows a position of resumption, the optical disk apparatus sends resuming-instruction of writing to CD encoder 113. The position of resumption of writing is writing-resuming position 306. When CD encoder 113 receives information of the resumption of writing, CD encoder 113 starts outputting data to laser-controlling circuit 114, and writing on optical disk 101 is started.

The case that position deviation 308 occurs between writing-interrupting position 305 and writing-resuming position 306 is described hereinafter. In theory, an error does not occur at the resumption of writing, because synchronizing circuit 112 synchronizes the data written on optical disk 101 and the data sent from CD encoder 113. However, when reproduced data shifts 1 bit from the reference clock signal by a controlling error of rotation of spindle motor 102 or jitter, position deviation 308 occasionally occurs at data for writing on optical disk 101.

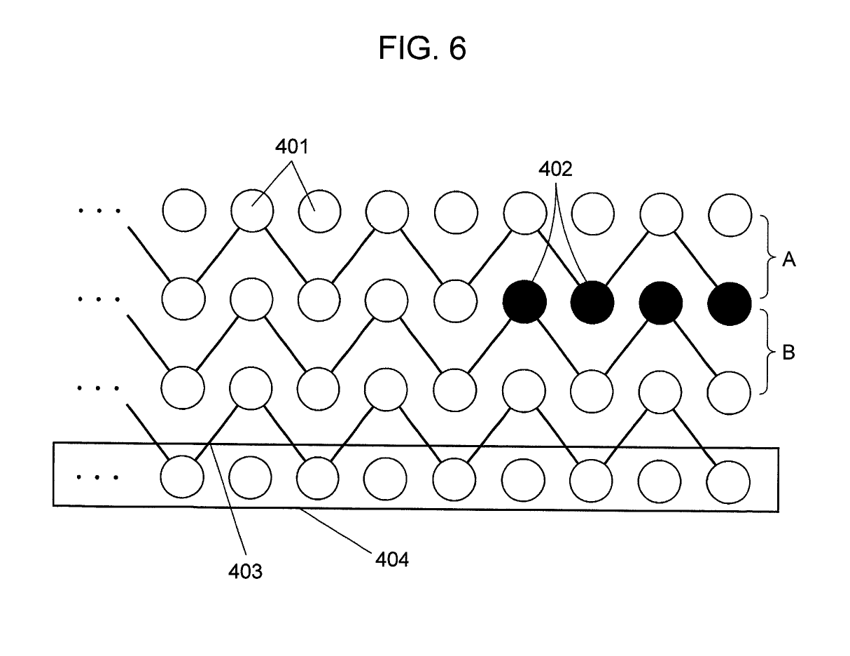

Writing data 309 written after the resumption of writing is read as an error data due to position deviation 308. However, the error data can be corrected by error-correction of C1 code. An operation of the error-correction is described hereinafter. FIG. 6 shows a chart explaining influence by an even-delaying operation of cross-interleaved-Reed-Solomon-code (CIRC) of the optical disk apparatus of the present invention.

FIG. 6 shows regular data 401 read regularly and error data 402 not read regularly. A white circle shows 1 byte of regular data 401 reproduced. Error data 402 is a data, which is not read regularly due to position deviation 308. A black circle shows 1 byte of error data 402. Combining data 403 is a data for combining data, which are used for error-correction of C1 code. White circles surrounded by frame 404 are data row in frame 302.

Combining data 403 extends over adjacent two frames 404, which are data rows in frame 302, by influence of the even-delaying operation of CIRC, so that error data 402 due to position deviation 308 are corrected by error-correction of C1 code of adjacent two data rows. In other words, only two errors exist in data within error-correction (group A or group B of error-correction in FIG. 6) of C1 code.

Two errors in each frame can be corrected by error-correction of C1 code, so that four errors can be corrected in data row in each frame 302. In a word, when error is within 4 bytes from the last of one frame, position deviation 308 is corrected by error-correction of C1 code based on CD standards.

In this embodiment, based on CD standards, an area where errors can be corrected is within 4 bytes. Based on other kinds of optical disk standards, the area is defined within an area from the last position of one frame to a position of the maximum possible number for correcting which the optical disk has. In other words, a data position within the area from the last position of one frame to the position of the maximum possible number for correcting, which the optical disk has, can be determined as writing-interrupting position 305.

As discussed above, in this invention, a position for interrupting of writing is determined by circuit 108 within 4 bytes from the last of one frame in the case of CD. In general, the position is in the area determined within the area from the last position of one frame to the position of the maximum possible number for correcting, which the optical disk has. As a result, writing is resumed with continuity of written data maintained. Even if error occurs due to position deviation 308 at resumption of writing, the error is corrected by C1 code of CIRC. Besides, even if error occurs at other positions, probability of impossibility of correcting an error substantially decreases. Without the correction above explained, when the error occurs due to position deviation 308, all data become errors until next frame-sync signal is received.

Thus the optical disk apparatus in the present invention decreases substantially probability of impossibility of correcting the error in the reading process, where the error results from deviation of the writing-resuming position in the resumption of the writing process.

### Third Embodiment

An operation (interrupting and resuming of writing on optical disk 101) of an optical disk apparatus in accordance with the third embodiment of this invention is explained hereinafter.

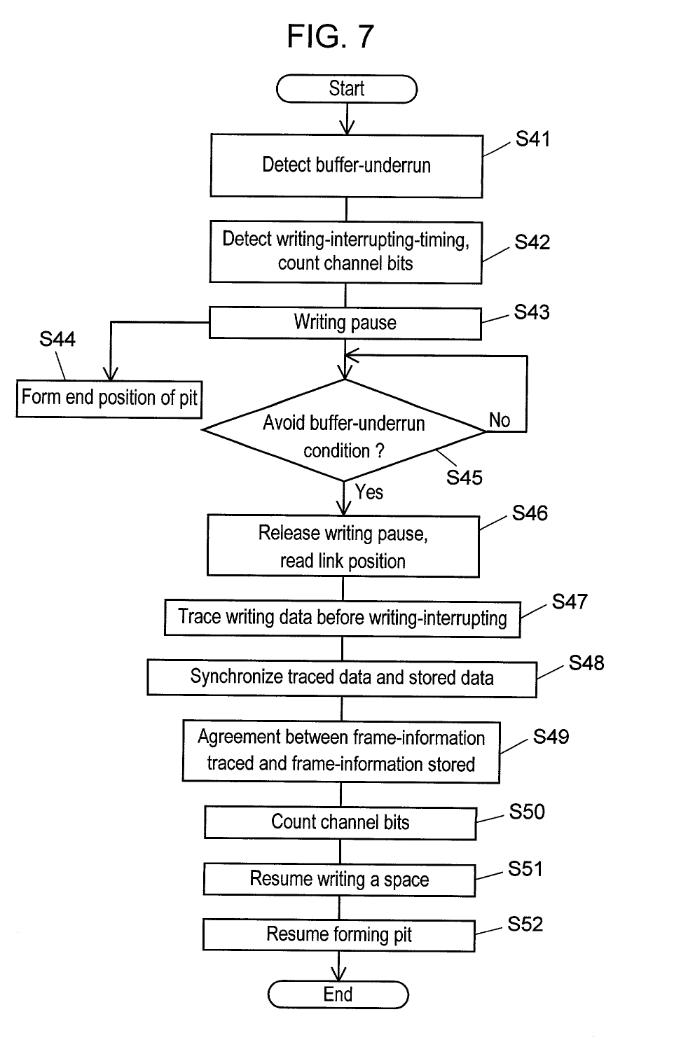

FIG. 7 shows a flowchart explaining interrupting and resuming of writing of the optical disk apparatus in accordance with the third embodiment of the present invention.

The third exemplary embodiment is demonstrated hereinafter with reference to FIGS. 1, 2, 4, and 7. In FIGS. 1, 2, 4, and 7, interrupting of writing on optical disk 101 is executed within an area from the last position of one frame to a position of the maximum possible number for correcting, which the optical disk has, and at link-position 204 after forming continuous pit 201.

In step 41, when an amount of data in buffer RAM 115 is not more than a given amount of data, buffer-underrun-detecting circuit 111 detects the buffer-underrun condition, and informs a buffer-underrun condition to writing-interrupting-and-resuming circuit 108.

In step 42, writing-interrupting-and-resuming circuit 108 detects an end position of pit 201 as writing-interrupting timing 205 in writing-pulse 202 based on the result of the buffer-underrun condition among data rows which are controlled by CD encoder 113. In addition to that, writing-interrupting-and-resuming circuit 108 counts channel bits using frame-sync signal 303 of frame n, which is an object for interrupting of writing, among data rows, which are controlled by CD encoder 113.

In step 43, writing-interrupting timing 205 is detected within 4 bytes from the last of frame n, the optical disk apparatus sends an interrupting-instruction of writing to CD encoder 113, thereby becomes in a pause condition of writing.

In step 44, writing-pulse 202 is interrupted at the position of writing-interrupting timing 205, and forms the end position of pit 201, so that the end position of pit 201 becomes link-position 204. An address of link-position 204 is stored in time-information memory 109.

In step 45, in the pause condition of writing, data for writing are sent from host PC 117, and new data are stored in buffer RAM 115, whereby the amount of the data in buffer RAM 115 becomes not less than the given amount of the data. As a result, buffer-underrun-detecting circuit 111 judges that the data in buffer RAM 115 are in the avoidance of the buffer-underrun condition.

In step 46, the optical disk apparatus sends the resuming-instruction of writing to CD encoder 113, and releases the pause condition of writing. The optical disk apparatus reads the address of link-position 204 from time-information memory 109, and reads new data from buffer RAM 115, where link-position 204 is the position of interrupting of writing.

In step 47, the optical disk apparatus informs resumption of writing to writing-interrupting-and-resuming circuit 108 based on the detected result of buffer-underrun-detecting circuit 111. Circuit 108 moves optical pick-up 103 to a position before writing-interrupting timing 205 (writing-interrupting position 305 in FIG. 4) on optical disk 101 by using servo circuit 107, and traces writing data 304 which is written on optical disk 101 before interrupting of writing.

In step 48, synchronizing circuit 112 synchronizes writing data 301, which is stored in CIRC data memory 110, and a reference clock signal in the optical disk apparatus, where the reference clock signal corresponds to writing data 304 traced and reproduced. Then synchronizing circuit 112 informs completion of synchronism to writing-interrupting-and-resuming circuit 108.

In step 49, circuit 108 obtains address-information from a sub code data decoded by CD decoder 105 or absolute time in pre-groove (ATIP), which is decoded by ATIP decoder 106, and operates CD encoder 113. Then circuit 108 synchronizes writing data 304 written on optical disk 101 and the encoded data (data for writing) of CD encoder 113. Circuit 108 waits agreement between frame-information, which is stored in time-information memory 109 at the interruption of writing, and the address-information and frame-information, which are being traced.

In step 50, when both frame-information agree each other, circuit 108 counts channel bits using frame-sync signal 303 of interrupted frame n.

In step 51, when the result of counting reaches within 4 bytes from the last of frame 302, the optical disk apparatus informs the resumption of writing to CD encoder 113. The position of the resumption of writing is writing-resuming timing 206 (writing-resuming position 306 in FIG. 4). When CD encoder 113 receives information of the resumption of writing, CD encoder 113 starts outputting data to laser-controlling circuit 114, and writing on optical disk 101 is started. A first data written after the resumption of writing (after writing-resuming position 306) is a space (condition without pits). In other words, writing-resuming position 306 is formed after forming continuous pit 201, so that the space certainly appears at a start of writing-resuming position 306. This first space is written as a new data, namely, writing-pulse 203 is non-active.

In step 52, an output of writing-pulse 203 is started from forming-pit-resuming timing 207, namely, writing-pulse 203 becomes active, and light power for forming next pit 209 is irradiated from optical pick-up 103.

As discussed above, the position of writing-interrupting timing 205 and writing-resuming timing 206 are determined as within 4 bytes from the last of one frame by error-correction of C1 code based on CD standards. In this embodiment, based on CD standards, an area where error can be corrected is within 4 bytes as well as that of the second embodiment. Based on other kinds of optical disk standards, the area is defined within an area from the last position of one frame to a position of the maximum possible number for correcting which the optical disk has. In other words, a data position within the area from the last position of one frame to the position of the maximum possible number for correcting, which the optical disk has, can be determined as the position of writing-interrupting timing 205 and writing-resuming timing 206.

As discussed above, in this invention, a position for interrupting of writing is determined by circuit 108 within 4 bytes from the last of one frame in the case of CD. In general, the position is in the area determined within the area from the last position of one frame to the position of the maximum possible number for correcting, which the optical disk has. As a result, writing is resumed with continuity of written data maintained. Link-position 204, where writing is interrupted, is formed between pit 201 and the space, so that regular edges are formed at pit 201 and pit 209, and discontinuity section does not occur during interrupting and resuming of writing.

Even if an error occurs due to position deviation 308 at resumption of writing, the error is corrected by C1 code of CIRC, and discontinuity section does not occur during interrupting and resuming of writing. As a result, probability of impossibility of correcting an error substantially decreases at interruption and resumption of writing. Besides the case of buffer-underrun condition, the writing method of information of this invention can be used for interrupting and resuming of writing generally as well as that of the embodiments afore explained.

Thus the optical disk apparatus in the present invention decreases substantially probability of impossibility of correcting the error in the reading process, where the error results from deviation of the writing-resuming position in the resumption of the writing process.

### Fourth Embodiment

An operation of interrupting and resuming of writing of an optical disk apparatus in accordance with the fourth embodiment is explained hereinafter, where an optical disk is a CD-Rewritable (CD-RW) based on CD standards.

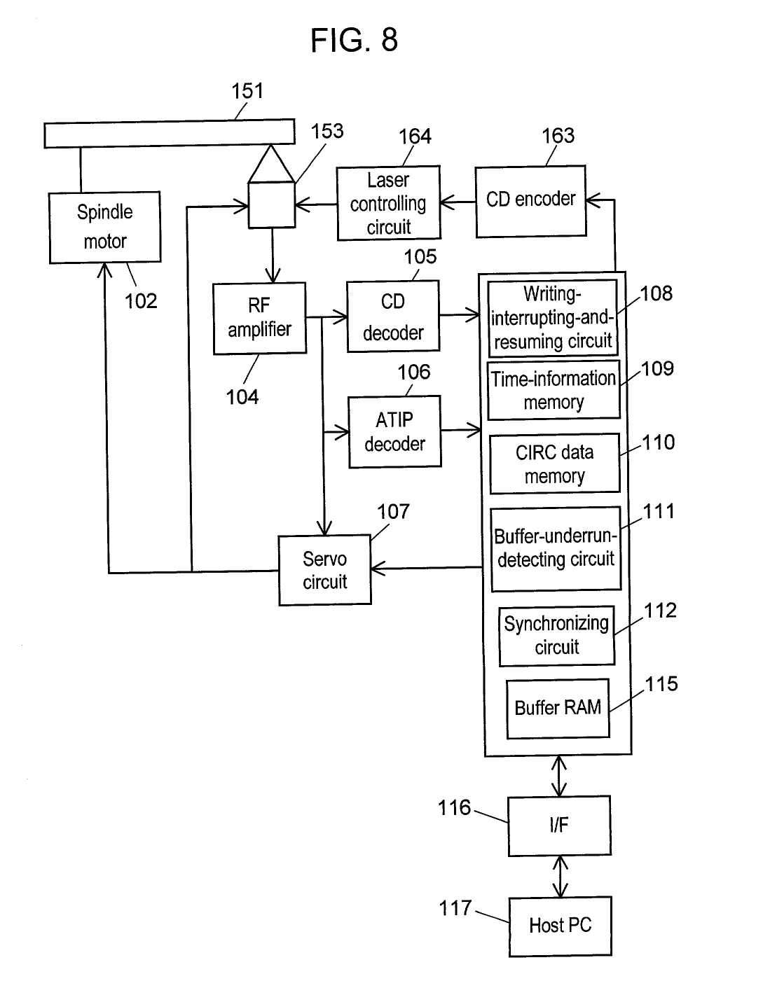

FIG. 8 shows a block diagram explaining a structure of the optical disk apparatus in accordance with the fourth embodiment of the present invention. In FIG. 8, optical disk 151 is a CD-RW. Optical pick-up 153 has a function for irradiating laser beam not only for writing but also for erasing. When laser beam for erasing is irradiated on optical disk 151 i.e., CD-RW, optical disk 151 is initialized.

Laser controlling circuit 164 has a function for controlling a writing operation and an erasing operation of optical pick-up 153. CD encoder 163 has a function for composing data lows and timing for writing, and composing data rows and timing for erasing. The elements similar to those shown in FIG. 1 have the same reference numerals, and the descriptions of these elements are omitted here.

The optical disk apparatus of this invention operates following interrupting and resuming of writing, where the optical disk used in the optical disk apparatus is CD-RW. In the case of interruption of writing, the optical disk apparatus of this invention detects an end position of a pit by writing-interrupting-and-resuming circuit 108, and stores the end position of the pit in time-information memory 109. Then a following position of the end position of the pit is initialized by irradiating laser beam for erasing from optical pick-up 153, and writing is interrupted.

According to CD standards, when one byte of data for writing is changed to 14 clock data (referred to as 14T) by eight to fourteen modulation (EFM) operation, a length of pit or a space is changed within 3T through 11T. When an area for initializing is not less than 11T after interrupting of writing, a sufficient space is formed.

In the case of resumption of writing, after timing of resumption of writing, when the space after the resumption of writing is written, laser source of optical pick-up 153 is operated, and irradiates laser beam for writing at timing of forming a pit, and then forming pits is resumed. In the case of interruption of writing, immediately after detecting the end position of the pit, the space is formed by initialization during not less than 11T. Then laser beam for writing is irradiated, and next pits are formed after the resumption of writing, so that the sufficient space is formed.

The optical disk apparatus of this invention initializes the area (not less than 11T), which is obtained by changing data using EFM operation. In the case of optical disk having other frame structures, a given space (period) of the longest pit (length of space) is initialized. The optical disk based on CD standards is discussed above, however, in the case of optical disk based on other optical disk standards, the maximum pit (space) length of the optical disk standards after the end position of the pit is initialized.

The operation of interrupting and resuming of writing of the optical disk apparatus of this invention is described in detail hereinafter with reference to the accompanying drawings.

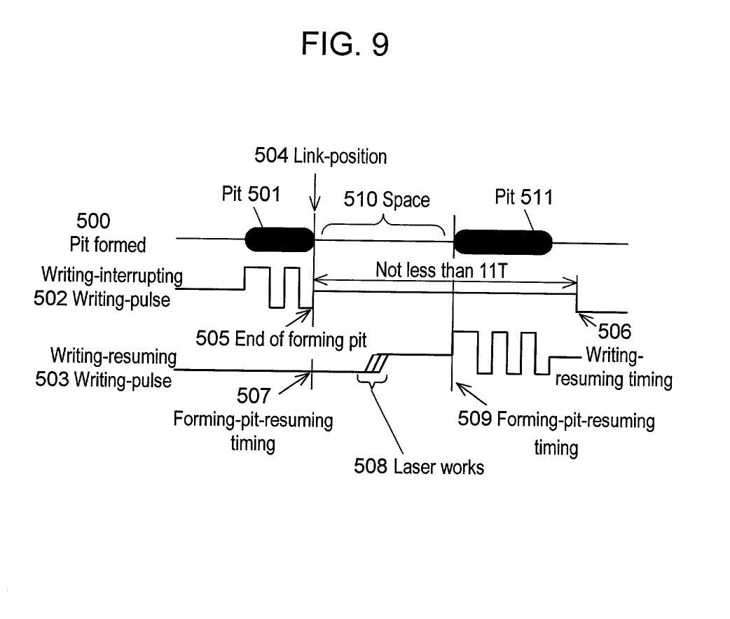

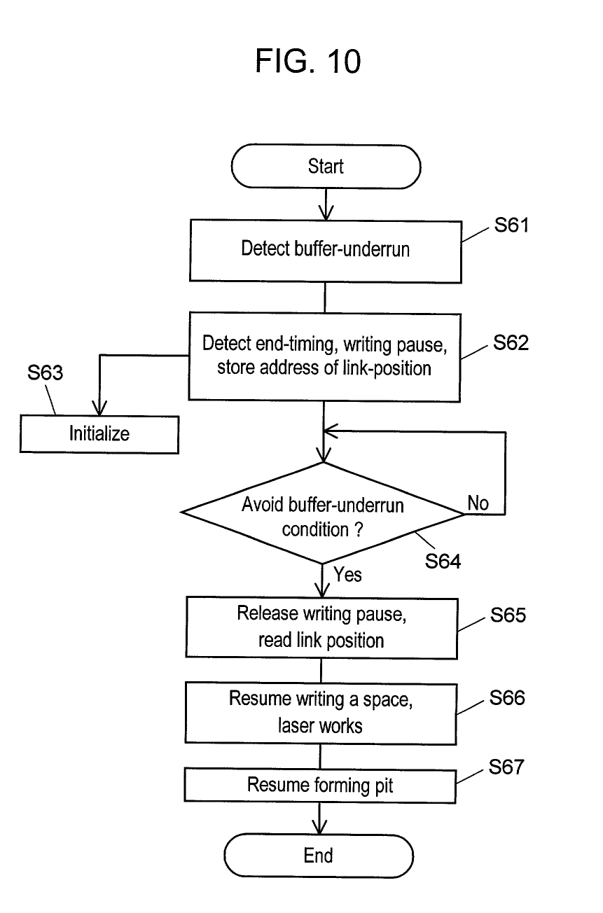

FIG. 9 shows a timing chart explaining interrupting and resuming of writing of the optical disk apparatus using the CD-RW of the present invention. FIG. 10 is a flowchart explaining interrupting and resuming of writing of the optical disk apparatus shown in FIG. 9.

FIG. 9 shows pit 500 for forming, writing-pulse 502 for interrupting of writing and writing-pulse 503 for resuming of writing.

In FIG. 9, pit 501 is formed immediately before interrupting, and space 510 is formed after resuming. Link-position 504 is an end position of pit 501 at interrupting of writing, and a joint of interrupting and resuming of writing.

In the start of interrupting of writing, end-timing 505 is an end timing of forming pit at an end position of writing-pulse 502 when continuous pit 501 is interrupted. Writing-interrupting timing 506 is timing after an area from link-position 504 (end-timing 505 of forming pits) to pit length not less than 11T obtained by changing data using EFM operation, and the area is erased by irradiating laser beam for erasing.

The operation of resuming of writing starts at writing-resuming timing 507. Writing-resuming timing 507 is timing of irradiating laser beam. At the resumption of writing, writing-pulse 503 resumes forming pits at forming-pit-resuming timing 509.

In FIGS. 8, 9 and 10, the interruption of writing on CD-RW executes at link-position 504 after forming continuous pit 501.

In step 61, when an amount of data in buffer RAM 115 is not more than a given amount of data, buffer-underrun-detecting circuit 111 detects the buffer-underrun condition.

In step 62, writing-interrupting-and-resuming circuit 108 detects the end position of pit 501 (link-position 504) as end-timing 505 of forming pit in writing-pulse 502 based on the detected result of the buffer-underrun condition among data rows, which are controlled by CD encoder 163. The optical disk apparatus sends the interrupting-instruction of writing to CD encoder 163, thereby becomes in the pause condition of writing. At the same time, the optical disk apparatus stores an address of link-position 504 in time-information memory 109. As discussed above, the address-information of optical disk 151 is changed into time-information.

In step 63, the optical disk apparatus irradiates laser beam for erasing and erases written data (pits) on a track area (not less than the pit length of 11T), which is obtained from end-timing 505 by changing data using EFM operation. In other words, not less than 11T pit length of tracks after link-position 504 are initialized, and irradiation of laser beam of erasing stops at the position of writing-interrupting timing 506.

In step 64, in the pause condition of writing, new data sent from host PC 117 are stored in buffer RAM 115, and the amount of the data in buffer RAM 115 becomes not less than the given amount of the data. As a result, buffer-underrun-detecting circuit 111 judges that the data in buffer RAM 115 are in the avoidance of the buffer-underrun condition.

In step 65, the optical disk apparatus sends the resuming-instruction of writing to CD encoder 163, and releases the pause condition of writing. The optical disk apparatus reads the address of link-position 504 from time-information memory 109, and reads new data from buffer RAM 115. Then the optical disk apparatus synchronizes link-position 504 written on optical disk 151 and encode data of CD encoder 163 (data for writing).

In step 66, A first data written after the resumption of writing (after writing-resuming timing 507) is space 510 (condition without pits). In other words, writing-resuming timing 507 is formed after forming continuous pit 501, so that the space certainly appears at a start of writing-resuming timing 507. This first space is written as a new data, namely, writing-pulse 503 does not exist, and irradiation 508 of laser beam works during space 510.

In step 67, an output of writing-pulse 503 is started from forming-pit-resuming timing 509, namely, laser beam for writing is irradiated. Because writing-pulse 503 for forming next pit 511 is irradiated from forming-pit-resuming timing 509, space 510 between pit 501 formed before interrupting of writing and pit 511 formed after resuming of writing becomes sufficient period.

As discussed above, the optical disk apparatus of this invention irradiates laser beam and erases written data on the area (not less than the pit length of 11T) obtained by changing data using EFM operation after link-position 504 (end-timing 505 of forming pits). In other words, written data (pits) are erased and disk track (area for writing) is initialized after end-timing 505.

As a result, at the resumption of writing, timing of irradiation 508 of laser beam is not required to be controlled with high accuracy, and writing starts by using formed space (condition without pits) at forming-pit-resuming timing 509 for writing next pit 511.

As mentioned above, in the optical disk apparatus using CD-RW of this invention, link-position 504 is formed between pit 501 and space 510. An area, which is not less than the longest pit (length of space), is initialized before resumption of writing. As a result, an end position of pit 501 becomes sufficient pit edge. Laser is irradiated in a period of space until next pit 511 is formed, and writing-pulse 503 becomes active at forming-pit-resuming timing 509, so that discontinuity section does not occur between the interruption of writing and the resumption of writing. In addition to that, at the resumption of writing, timing of irradiation 508 of laser beam is not required to be controlled with high accuracy.

Thus probability of impossibility of correcting the error in the reading process substantially decreases, where the error results from deviation of the writing-resuming position in the resumption of the writing process.

The optical disk apparatus of the embodiments afore explained is described using the specific standard discussed above, however, when the optical disk apparatus is used in other standards, condition or numerals can be changed based on the standards.

What is claimed is:

1. An optical disk apparatus for writing data on an optical disk by a given laser beam having:
(a) a rotating means for rotating the optical disk;
(b) an optical pick-up for reproducing a data from the optical disk or writing a data on the optical disk by irradiating the laser beam on the optical disk;
(c) a laser controlling means for controlling light power of the laser beam;
(d) a demodulating means for binarizing and demodulating the data reproduced;
(e) an absolute time in pre-groove (ATIP) demodulating means for extracting a wobble signal from the data reproduced; and
(f) a buffer for storing the data for writing temporarily,
said optical disk apparatus comprising:
(a) a buffer-underrun-detecting means for monitoring an amount of the data stored temporarily in the buffer, namely, an amount of the data for writing, and judging that the data are in a buffer-underrun condition when the amount of the data becomes not more than a given amount of data;
(b) a writing interrupting and resuming means for writing the data on the optical disk at a given position;
(c) a time-information memory for storing the data of a last time of interrupted writing or an address;
(d) a synchronizing means for synchronizing the data written on the optical disk and a given clock signal; and
(e) a modulating means for synchronizing the data for writing and the given clock signal, and outputting a synchronized signal after modulating,
wherein a given interval is formed between the data written on the optical disk and the data for writing, and writing is resumed.

2. The optical disk apparatus of claim 1,
wherein the given interval is a space, which appears at a start of the resumption of writing.

3. The optical disk apparatus of claim 1,
wherein the given interval is formed within an area from a last position of one frame to a position of a maximum possible number for correcting which the optical disk has.

4. The optical disk apparatus of claim 1,
wherein the given interval is formed within an area from a last position of one frame to a position of a maximum possible number for correcting which the optical disk has, and the given interval is a space, which appears at a start of the resumption of writing.

5. The optical disk apparatus of claim 1,
wherein the optical disk is rewritable, and initialized after interruption of writing,
wherein the given interval is a space, which appears at a start of the resumption of writing in the initialized area of the optical disk.

6. An optical disk apparatus for writing data on an optical disk by a given laser beam having:
(a) a rotating means for rotating the optical disk;
(b) an optical pick-up for reproducing a data from the optical disk or writing a data on the optical disk by irradiating the laser beam on the optical disk;
(c) a laser controlling means for controlling light power of the laser beam;
(d) a demodulating means for binarizing and demodulating the data reproduced;
(e) an absolute time in pre-groove (ATIP) demodulating means for extracting a wobble signal from the data reproduced; and
(f) a buffer for storing the data for writing temporarily,
said optical disk apparatus comprising:
(a) a buffer-underrun-detecting means for monitoring an amount of the data stored temporarily in the buffer, namely, an amount of the data for writing, and judging that the data are in a buffer-underrun condition when the amount of the data becomes not more than a given amount of data;
(b) a writing interrupting and resuming means for writing the data on the optical disk at a given position;
(c) a time-information memory for storing the data of a last time of interrupted writing or an address;
(d) a synchronizing means for synchronizing the data written on the optical disk and a given clock signal; and
(e) a modulating means for synchronizing the data for writing and the given clock signal, and outputting a synchronized signal after modulating,
wherein when said buffer-underrun-detecting means judges that the data are in the buffer-underrun condition, and said writing interrupting and resuming means detects a position for interrupting of writing, writing is interrupted,
wherein when said buffer-underrun-detecting means judges that the data are in an avoidance of the buffer-underrun condition, a given interval is formed between the data written on the optical disk and the data for writing, and writing is resumed.

7. The optical disk apparatus of claim 6,
wherein the position for interrupting of writing is an end position of a pit, and the given interval is a space, which appears at a start of the resumption of writing.

8. The optical disk apparatus of claim 6,
wherein the position for interrupting of writing is formed within an area from a last position of one frame to a position of a maximum possible number for correcting which the optical disk has,
wherein the given interval is an area synchronized the data written on the optical disk and the data for writing.

9. The optical disk apparatus of claim 6,
wherein the position for interrupting of writing is formed within an area from a last position of one frame to a position of a maximum possible number for correcting which the optical disk has,
wherein the given interval is a position synchronized the data written on the optical disk and the data for writing, and the given interval is a space, which appears at a start of the resumption of writing.

10. The optical disk apparatus of claim 6,
wherein the optical disk is rewritable,
wherein the optical pick-up has a function for irradiating laser beam for writing and erasing,
wherein the laser controlling means has a function for controlling a writing operation and a erasing operation of the optical pick-up,
wherein said modulating means has a function for synchronizing the data for writing and the given clock signal, and outputting a synchronized signal after modulating, and has a function for synchronizing the data for erasing and the given clock signal, and outputting a synchronized signal after modulating,
wherein the position for interrupting of writing is an end position of a pit,
wherein after interruption of writing, at least an area of the maximum pit length of an optical disk standard after the end position of the pit is initialized,
wherein the given interval is a space, which appears at a start of the resumption of writing in the initialized area.

11. An optical disk apparatus for writing data on an optical disk by a given laser beam having:
(a) a rotating means for rotating the optical disk;
(b) an optical pick-up for reproducing a data from the optical disk or writing a data on the optical disk by irradiating the laser beam on the optical disk;
(c) a laser controlling means for controlling light power of the laser beam;
(d) a demodulating means for binarizing and demodulating the data reproduced;
(e) an absolute time in pre-groove (ATIP) demodulating means for extracting a wobble signal from the data reproduced; and
(f) a buffer for storing the data for writing temporarily,
said optical disk apparatus comprising:
(a) a buffer-underrun-detecting means for monitoring an amount of the data stored temporarily in the buffer, namely, an amount of the data for writing, and judging that the data are in a buffer-underrun condition when the amount of the data becomes not more than a given amount of data;
(b) a writing interrupting and resuming means for writing the data on the optical disk at a given position;
(c) a time-information memory for storing the data of a last time of interrupted writing or an address;
(d) a synchronizing means for synchronizing the data written on the optical disk and a given clock signal; and
(e) a modulating means for synchronizing the data for writing and the given clock signal, and outputting a synchronized signal after modulating,
wherein when said buffer-underrun-detecting means judges that the data are in the buffer-underrun condition, and said writing interrupting and resuming means detects a position for interrupting of writing, writing is interrupted at an end position of a pit,
wherein when said buffer-underrun-detecting means judges that the data are in an avoidance of the buffer-underrun condition, the data written on the optical disk and the data for writing are synchronized, and writing is resumed from a space, which appears at a start of the resumption of writing.

12. An optical disk apparatus for writing data on an optical disk by a given laser beam having:
(a) a rotating means for rotating the optical disk;
(b) an optical pick-up for reproducing a data from the optical disk or writing a data on the optical disk by irradiating the laser beam on the optical disk;
(c) a laser controlling means for controlling light power of the laser beam;
(d) a demodulating means for binarizing and demodulating the data reproduced;
(e) an absolute time in pre-groove (ATIP) demodulating means for extracting a wobble signal from the data reproduced; and
(f) a buffer for storing the data for writing temporarily,
said optical disk apparatus comprising:
(a) a buffer-underrun-detecting means for monitoring an amount of the data stored temporarily in the buffer, namely, an amount of the data for writing, and judging that the data are in a buffer-underrun condition when the amount of the data becomes not more than a given amount of data;
(b) a writing interrupting and resuming means for writing the data on the optical disk at a given position;
(c) a time-information memory for storing the data of a last time of interrupted writing or an address;
(d) a synchronizing means for synchronizing the data written on the optical disk and a given clock signal; and
(e) a modulating means for synchronizing the data for writing and the given clock signal, and outputting a synchronized signal after modulating,
wherein when said buffer-underrun-detecting means judges that the data are in the buffer-underrun condition, and said writing interrupting and resuming means detects a position for interrupting of writing, writing is interrupted within an area from a last position of one frame to a position of a maximum possible number for correcting which the optical disk has,
wherein when said buffer-underrun-detecting means judges that the data are in an avoidance of the buffer-underrun condition, the data written on the optical disk and the data for writing are synchronized, and writing is resumed at a position, which is a result of counting channel bits and within an area from the last position of one frame to the position of the maximum possible number for correcting which the optical disk has.

13. The optical disk apparatus of claim 12,
wherein the optical disk is a write-once-read-many optical disk,
wherein the position from the last position of one frame to the position of the maximum possible number for correcting, which the optical disk has, is a position within 4 bytes from the last position of the frame.

14. An optical disk apparatus for writing data on an optical disk by a given laser beam having:
(a) a rotating means for rotating the optical disk;
(b) an optical pick-up for reproducing a data from the optical disk or writing a data on the optical disk by irradiating the laser beam on the optical disk;
(c) a laser controlling means for controlling light power of the laser beam;
(d) a demodulating means for binarizing and demodulating the data reproduced;
(e) an absolute time in pre-groove (ATIP) demodulating means for extracting a wobble signal from the data reproduced; and
(f) a buffer for storing the data for writing temporarily,
said optical disk apparatus comprising:
(a) a buffer-underrun-detecting means for monitoring an amount of the data stored temporarily in the buffer, namely, an amount of the data for writing, and judging that the data are in a buffer-underrun condition when the amount of the data becomes not more than a given amount of data;
(b) a writing interrupting and resuming means for writing the data on the optical disk at a given position;
(c) a time-information memory for storing the data of a last time of interrupted writing or an address;
(d) a synchronizing means for synchronizing the data written on the optical disk and a given clock signal; and
(e) a modulating means for synchronizing the data for writing and the given clock signal, and outputting a synchronized signal after modulating,
wherein when said buffer-underrun-detecting means judges that the data are in the buffer-underrun condition, and said writing interrupting and resuming means detects a position for interrupting of writing, writing is interrupted within an area from a last position of one frame to a position of a maximum possible number for correcting which the optical disk has,
wherein when said buffer-underrun-detecting means judges that the data are in an avoidance of the buffer-underrun condition, the data written on the optical disk and the data for writing are synchronized, and writing is resumed from a space,
wherein the space is a result of counting channel bits and within an area from the last position of the frame to the position of the maximum possible number for correcting which the optical disk has, and appears at a start of the resumption of writing.

15. The optical disk apparatus of claim 14,
wherein the optical disk is a write-once-read-many optical disk,
wherein the position from the last position of one frame to the position of the maximum possible number for correcting, which the optical disk has, is a position within 4 bytes from the last position of the frame.

16. An optical disk apparatus for writing data on a rewritable optical disk by a given laser beam having:
(a) a rotating means for rotating the optical disk;
(b) an optical pick-up for reproducing a data from the optical disk or writing or erasing a data on the optical disk by irradiating the laser beam on the optical disk;
(c) a laser controlling means for controlling a writing operation and an erasing operation of the optical pick-up by controlling light power of the laser beam;
(d) a demodulating means for binarizing and demodulating the data reproduced;
(e) an absolute time in pre-groove (ATIP) demodulating means for extracting a wobble signal from the data reproduced; and
(f) a buffer for storing the data for writing temporarily,
said optical disk apparatus comprising:
(a) a buffer-underrun-detecting means for monitoring an amount of the data stored temporarily in the buffer, namely, an amount of the data for writing, and judging that the data are in a buffer-underrun condition when the amount of the data becomes not more than a given amount of data;
(b) a writing interrupting and resuming means for writing the data on the optical disk at a given position;
(c) a time-information memory for storing the data of a last time of interrupted writing or an address;
(d) a synchronizing means for synchronizing the data written on the optical disk and a given clock signal; and
(e) a modulating means for synchronizing the data for writing and the given clock signal, and outputting a synchronized signal after modulating in the writing operation, and synchronizing the data for erasing and the given clock signal, and outputting a synchronized signal after modulating in the erasing operation;
wherein when said buffer-underrun-detecting means judges that the data are in the buffer-underrun condition, and said writing interrupting and resuming means detects a position for interrupting of writing, writing is interrupted at an end position of a pit,
wherein after interruption of writing, at least an area of a maximum pit length of an optical disk standard after the end position of the pit is initialized,
wherein when said buffer-underrun-detecting means judges that the data are in an avoidance of the buffer-underrun condition, the data written on the optical disk and the data for writing are synchronized, and writing is resumed from a space, which appears at a start of the resumption of writing in the initialized area.

17. The optical disk apparatus of claim 16,
wherein the optical disk is a CD-RW, and the maximum pit length of the optical disk standard is data of 11 clocks obtained by changing the data using EFM operation.
